(19) United States
(12) Patent Application Publication
(10) Pub. No.: US 2015/0146006 A1
(43) Pub. Date: May 28, 2015

(54) DISPLAY CONTROL APPARATUS AND DISPLAY CONTROL METHOD

(71) Applicant: CANON KABUSHIKI KAISHA, Tokyo (JP)

(72) Inventor: Atsushi Kawano, Tokyo (JP)

(21) Appl. No.: 14/519,453

(22) Filed: Oct. 21, 2014

(30) Foreign Application Priority Data
Nov. 26, 2013 (JP) 2013-244335

(51) Int. Cl. H04N 5/232; H04N 7/18

(52) U.S. Cl. CPC H04N 5/23293; H04N 7/181
USPC 348/159

(57) ABSTRACT

A display control apparatus for controlling display of images captured by a plurality of cameras compares an analysis result corresponding to an image captured by a first camera of the plurality of cameras with an analysis result corresponding to an image captured by a second camera corresponding to the first camera, and controls to display the image captured by the first camera in a form based on a comparison result.

### BACKGROUND OF THE INVENTION

1. Field of the Invention

The present invention relates to a display control apparatus and method for controlling display of images captured by a plurality of cameras.

2. Description of the Related Art

There is conventionally known a congestion estimation system for estimating the degree of congestion within a capturing range from a video captured by a monitoring camera. USP 2010/0177963 and Japanese Patent Laid-Open Nos. 2012-118790 and 2012-198821 disclose the following techniques.

USP 2010/0177963 discloses a congestion estimation apparatus for determining whether a person exists in a video by comparing reference motion information and texture information with motion information and image texture information which are obtained from a moving image.

Japanese Patent Laid-Open No. 2012-118790 discloses an apparatus for determining whether the degree of congestion is normal or abnormal by comparing a pedestrian traffic measurement result obtained by measuring pedestrian traffic in a video with a pedestrian traffic pattern for each time period. There is also known a system for improving the accuracy of a sensing result by integrating the analysis results of a plurality of monitoring camera videos.

Japanese Patent Laid-Open No. 2012-198821 discloses the following system. That is, intruder sensing processing is performed for each of a plurality of monitoring camera videos obtained by capturing different regions, thereby outputting a result indicating that an intruder has been sensed or no intruder has been sensed. When an intruder is sensed in one of the monitoring camera videos, if a sensing result is obtained from another monitoring camera video at the same time or within a predetermined period, the sensing result is determined as a sensing error due to a change in environment.

According to USP 2010/0177963 and Japanese Patent Laid-Open No. 2012-118790, it is possible to provide a monitor who monitors a monitoring camera with a congestion determination result about a video of an individual monitoring camera. With this method of making determination according to a video of an individual monitoring camera, however, a congestion state is determined even in a state in which it is not necessary to specifically pay close attention. For example, even though a congestion state is normal in a station during the rush hours, a congestion state is determined. As a result, even in the normal state, the monitor continuously receives a determination result indicating a congestion state. This causes degradation in consciousness of the monitor about a sensing result.

According to Japanese Patent Laid-Open No. 2012-198821, a sensing error due to a change in environment is reduced by integrating sensing results in the entire system. This technique, however, considers only a sensing error derived from a change in environment that simultaneously changes images in a plurality of cameras. Therefore, an accurate sensing result cannot be always obtained.

### SUMMARY OF THE INVENTION

The present invention provides a technique of appropriately displaying an analysis result corresponding to an image captured by a camera.

According to the first aspect of the present invention, there is provided a display control apparatus for controlling display of images captured by a plurality of cameras, comprising: a comparison unit configured to compare an analysis result corresponding to an image captured by a first camera of the plurality of cameras with an analysis result corresponding to an image captured by a second camera corresponding to the first camera; and a control unit configured to control to display the image captured by the first camera in a form based on a result of the comparison by the comparison unit.

According to the second aspect of the present invention, there is provided a display control method of controlling display of images captured by a plurality of cameras, comprising: comparing an analysis result corresponding to an image captured by a first camera of the plurality of cameras with an analysis result corresponding to an image captured by a second camera corresponding to the first camera; and controlling to display the image captured by the first camera in a form based on a result of the comparison.

Further features of the present invention will become apparent from the following description of exemplary embodiments with reference to the attached drawings.

### BRIEF DESCRIPTION OF THE DRAWINGS

FIG. 1 is a view for explaining an example of an information processing system in a station yard;

FIG. 2 is a block diagram showing an example of the functional arrangement of the information processing system;

FIG. 3 is a view showing an example of a captured image;

FIG. 4 is a table showing an example of the structure of installation position information;

FIGS. 5A and 5B are views each showing an example of display of captured images;

FIG. 6 is a flowchart illustrating processing executed by an information processing apparatus 106;

FIG. 7 is a flowchart illustrating processing executed by the information processing apparatus 106;

FIG. 8 is a block diagram showing an example of the functional arrangement of an information processing system; and

FIG. 9 is a block diagram showing an example of the hardware arrangement of an apparatus applicable to an information processing apparatus 106.

### DESCRIPTION OF THE EMBODIMENTS

Embodiments of the present invention will be described below with reference to the accompanying drawings. Note that the embodiments to be described below are merely examples when the present invention is practiced concretely, and are practical embodiments of arrangements described in the appended claims.

An information processing system according to the first embodiment acquires captured images of a plurality of cameras installed outside and inside, and performs congestion sensing processing, integrated determination processing, and display control using the captured images.

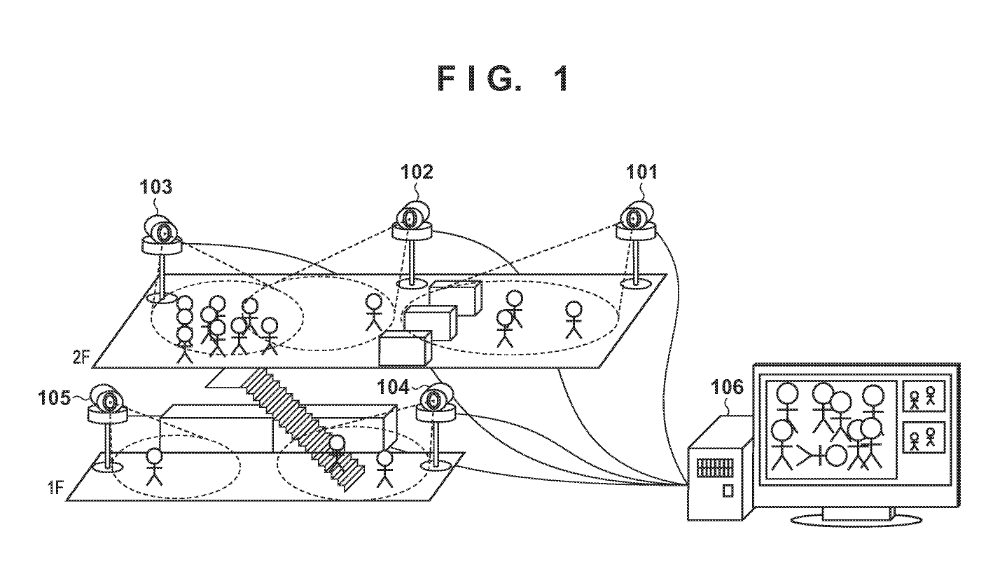

An information processing system for confirming whether each of five cameras (cameras 101 to 105) installed in a station yard, as shown in FIG. 1, captures a congestion state or non-congestion state will be explained below. An application target of the information processing system according to this embodiment is not limited a case (to be described below) in which a congestion state is confirmed for each camera in the station yard. Various applications are possible. Although the number of cameras is “five” in FIG. 1, the present invention is not limited to this.

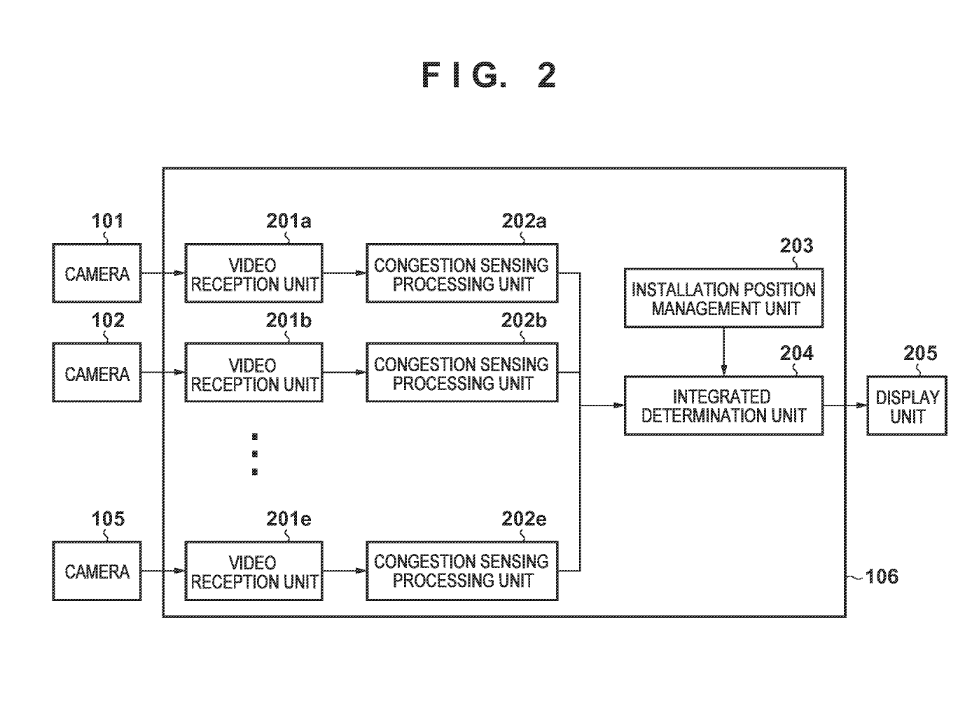

An example of the functional arrangement of the information processing system according to this embodiment will be described with reference a block diagram shown in FIG. 2. As shown in FIG. 2, the information processing system according to this embodiment includes the cameras 101 to 105, an information processing apparatus 106 capable of receiving a captured image captured by each of the cameras 101 to 105, and a display unit 205 capable of displaying the processing result of the information processing apparatus 106.

The cameras 101 to 105 will be explained first. As shown in FIG. 1, each of the cameras 101 to 105 is installed at a predetermined position in the station yard to capture a predetermined direction. Each camera captures a capturing range, and sends the captured image to the information processing apparatus 106. Note that each of the cameras 101 to 105 captures a moving image, and sequentially sends, as captured images, the images of respective frames forming the moving image to the information processing apparatus 106. However, each camera may capture a still image at an arbitrary timing, and send the still image as a captured image to the information processing apparatus 106.

Note that the cameras 101 to 103 are installed on the second floor, and the cameras 104 and 105 are installed on a platform on the first floor. The camera 101 captures a region of a gate and a concourse outside the gate, and the camera 102 captures a region of the station yard inside the gate. The camera 103 captures a region at the top of stairs on the second floor, and the camera 104 captures a region at the foot of the stairs on the first floor.

The display unit 205 will be described next. The display unit 205 is formed from a CRT, a liquid crystal screen, or the like, and can display the processing result of the information processing apparatus 106 using images, characters, and the like. Note that the display unit 205 may be a display device directly connected to the information processing apparatus 106 or a display device included in an apparatus connected to the information processing apparatus 106 via a network.

The information processing apparatus 106 will be described next. Each of video reception units 201a to 201e receives the captured image sent from a corresponding one of the cameras 101 to 105 via a network, and sends the received image to a corresponding one of congestion sensing processing units 202a to 202e of the succeeding stage.

Each of the congestion sensing processing units 202a to 202e generates congestion information based on the captured image received from a corresponding one of the video reception units 201a to 201e, and sends the generated congestion information to an integrated determination unit 204 of the succeeding stage.

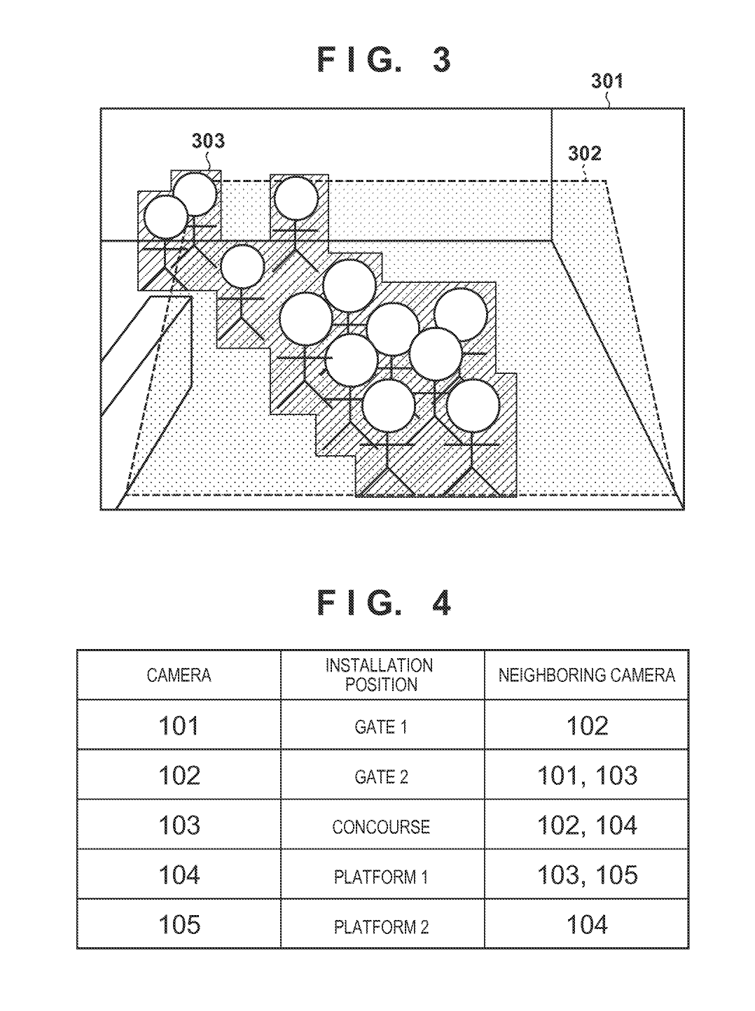

The congestion sensing processing unit 202a will be exemplified. As shown in FIG. 3, the congestion sensing processing unit 202a detects a moving object region 303 in a predetermined region (congestion sensing region) 302 set in advance in a captured image 301 received from the video reception unit 201a by using a background difference method. The congestion sensing processing unit 202a obtains, as the degree of congestion, the area ratio of the area of the overlapping region of the congestion sensing region 302 and the moving object region 303 to the area of the congestion sensing region 302 (a numerical value representing (the area of the overlapping region of the congestion sensing region 302 and the moving object region 303)/(the area of the congestion sensing region 302) by 101 levels from 0 to 100).

Furthermore, the congestion sensing processing unit 202a compares the magnitude of the degree of congestion with that of a predetermined threshold (for example, 80). If the degree of congestion ≧the threshold (the degree of congestion is equal to or higher than the threshold), it is determined that the camera 101 has captured a congestion state (the captured image 301 is an image (congestion image) obtained by capturing a congestion state). On the other hand, if the degree of congestion <the threshold (the degree of congestion is lower than the threshold), it is determined that the camera 101 has captured a non-congestion state (the captured image 301 is an image (non-congestion image) obtained by capturing a non-congestion state).

The congestion sensing processing unit 202a generates congestion information containing a set of the previously obtained degree of congestion and capturing information (determination result) indicating whether the camera 101 has captured a congestion state or non-congestion state, and sends the generated congestion information to the integrated determination unit 204 of the succeeding stage. Each of the congestion sensing processing units 202b to 202e performs the same processing.

Note that each of the congestion sensing processing units 202a to 202e may achieve the same object by another processing as long as it is possible to generate congestion information described above from the captured image, and output the generated congestion information. For example, although the moving object region 303 is detected using the background difference method in the above example, the moving object region 303 may be detected using another method. The method described in USP 2010/0177963 may be used to acquire the same congestion information. Alternatively, a human body within a congestion sensing region may be detected by human body detection based on the co-occurrence of image local feature amounts, and congestion information may be generated based on the number of detected human bodies.

In the above example, the predetermined threshold is common to the cameras 101 to 105. However, different thresholds may be used for the respective cameras.

An installation position management unit 203 manages, for each of the cameras 101 to 105, installation position information containing the installation position of the camera and the installation position of a neighboring camera installed near the camera on a line of flow. In this installation position information, a neighboring camera installed near each of the cameras 101 to 105 is registered in correspondence with the camera. Note that “a neighboring camera installed near the camera on a line of flow” satisfies the following three conditions.

<Condition 1> The camera is on a line of flow in a facility (the station yard in this embodiment).
<Condition 2> The camera captures another region.
<Condition 3> The actual distance between the cameras is equal to or shorter than a predetermined distance.

Note that a setting user may determine whether these conditions are satisfied, and register information in the installation position management unit 203 using a keyboard (not shown).

Alternatively, the information processing apparatus 106 may determine whether the conditions are satisfied without using the input of an installation manager by referring to the design drawing of the station indicating the installation positions and capturing directions of the cameras, as will be described below.

For example, cameras near the camera 103 shown in FIG. 1 on a line of flow are the camera 102 installed before the gate and the camera 104 installed on the platform floor (first floor) connected by the stairs (in this case, the distances between the camera 103 and the cameras 102 and 104 respectively satisfy condition 3).

An example of the structure of the installation position information for managing the above information for each of the cameras 101 to 105 installed in the station yard, as shown in FIG. 1, will be described with reference to FIG. 4. In the installation position information, the installation position of each of the cameras 101 to 105 and a neighboring camera installed near the camera are registered in correspondence with the camera. FIG. 4 shows the cameras 101 to 105 by reference numerals, respectively. An ID unique to each camera may be used, or any information may represent each camera as long as it is possible to identify each camera.

With reference to the installation position information of FIG. 4, it is found that, for example, the camera 102 is installed at gate 2, and the cameras 101 and 103 are installed near the camera 102 on a line of flow as neighboring cameras corresponding to the camera 102. As described above, by referring to the installation information, it is possible to specify the installation position of each of the cameras 101 to 105, and specify a camera (neighboring camera) near each camera on a line of flow.

Note that in the above description, “a neighboring camera installed near the camera on a line of flow” satisfies <Condition 1> to <Condition 3> described above. Conditions which should be satisfied by “a neighboring camera installed near the camera on a line of flow” are not limited to them. Any combination of conditions may be used as conditions which should be satisfied by “a neighboring camera installed near the camera on a line of flow” as long as <Condition 1> is satisfied and a condition which can define a combination of neighboring cameras is satisfied.

For example, instead of <Condition 2> described above, a condition that “capturing ranges are close to each other” may be adopted, or <Condition 3> may be excluded from the conditions which should be satisfied by “a neighboring camera installed near the camera on a line of flow”.

By using the congestion information sent from each of the congestion sensing processing units 202a to 202e and the installation position information managed by the installation position management unit 203, the integrated determination unit 204 confirms whether each of the cameras 101 to 105 is capturing a congestion state or non-congestion state. In this confirmation processing (integrated determination of a congestion state), it is determined for each of the cameras 101 to 105 whether (rule 1) and (rule 2) below are satisfied.

(Rule 1) A self camera is capturing a congestion state and all neighboring cameras corresponding to the self camera are capturing a non-congestion state.

(Rule 2) The difference between the degree of congestion (the area ratio of a moving object region) for the self camera and that for each of all the neighboring cameras corresponding to the self camera is equal to or larger than a predetermined value (for example, 50).

For example, the camera 102 will be exemplified. Since the integrated determination unit 204 recognizes based on the installation position information that the neighboring cameras of the camera 102 are the cameras 101 and 103, it refers to the capturing information in the congestion information for each of the cameras 101 to 103. The integrated determination unit 204 determines whether the capturing information in the congestion information of each of the cameras 101 to 103 indicates that a congestion state has been captured or that a non-congestion state has been captured. If the camera 102 is capturing a congestion state and the cameras 101 and 103 are capturing a non-congestion state, the integrated determination unit 204 determines that (rule 1) described above is satisfied.

The integrated determination unit 204 refers to the degree of congestion in the congestion information for each of the cameras 101 to 103. If the result of subtracting the degree of congestion of the camera 101 from that of the camera 102 is equal to or larger than a predetermined value and the result of subtracting the degree of congestion of the camera 103 from that of the camera 102 is equal to or larger than the predetermined value, the integrated determination unit 204 determines that (rule 2) is satisfied.

If both (rule 1) and (rule 2) are satisfied, the integrated determination unit 204 confirms that “the camera 102 is a camera that has captured a congestion state”. On the other hand, if at least one of (rule 1) and (rule 2) is not satisfied, the integrated determination unit 204 confirms that “the camera 102 is a camera that has captured a non-congestion state).

Note that instead of the combination of (rule 1) and (rule 2), various combinations of rules in which the degree of congestions of a self camera and a neighboring camera are compared may be used. The rule may be changed according to the installation statuses of the cameras. For example, if the capturing ranges of a self camera and a neighboring camera overlap each other, (rule 1) described above may be changed to a rule “the self camera is capturing a congestion state, one of the neighboring cameras is capturing a congestion state, and the other neighboring camera is capturing a non-congestion state”. Furthermore, (rule 2) may be changed to a rule “the difference between the degree of congestion for the self camera and that for a neighboring camera that has been determined to have captured a non-congestion state among all the neighboring cameras corresponding to the self camera is equal to or larger than a predetermined value (for example, 50)”.

As described above, every time each of the cameras 101 to 105 inputs a captured image to the information processing apparatus 106, the information processing apparatus 106 performs the above-described processing, and confirms whether each of the cameras 101 to 105 has captured a congestion state or non-congestion state.

However, depending on the input congestion information, a confirmation result (integrated determination result) may change between a congestion state and a non-congestion state. If the integrated determination result changes, the integrated determination result may be decided by smoothing of results, for example, a moving average.

In this embodiment, as described above, a confirmation result is obtained by rule processing using the rules. The same object may be achieved by a method other than the rule processing. That is, it is only necessary to use a method of determining the congestion state of each camera by integrating the congestion information of each camera and that of a neighboring camera on a line of flow and evaluating the integrated information.

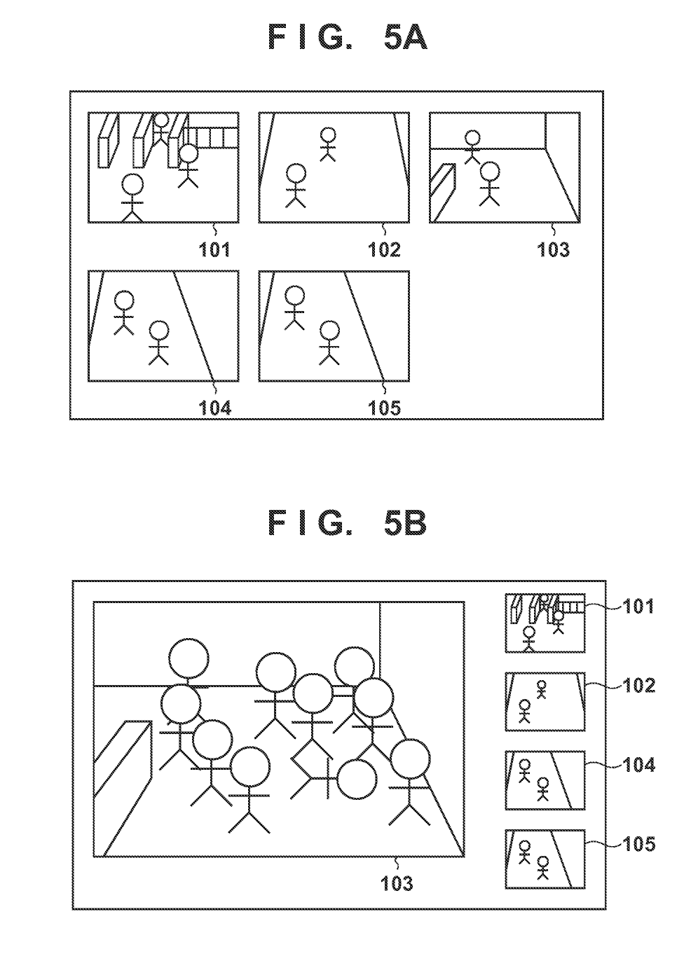

The display unit 205 displays the captured image of each of the cameras 101 to 105 in a display form according to the confirmation result for the camera. FIG. 5A shows an example of display of the captured images of the cameras 101 to 105 when the confirmation result of each of the cameras 101 to 105 indicates a non-congestion state (normal state). As shown in FIG. 5A, if the confirmation result of each of the cameras 101 to 105 indicates a non-congestion state, the captured images of the cameras 101 to 105 are listed and displayed at the same size.

On the other hand, FIG. 5B shows an example of display of the captured images of the cameras 101 to 105 when the confirmation result of the camera 103 indicates a congestion state and the confirmation results of the cameras 101, 102, 104, and 105 indicate a non-congestion state. As shown in FIG. 5B, if only the camera 103 is confirmed to have captured a congestion state, the captured image of the camera 103 is displayed at a size larger than that in the normal state and the captured images of the cameras 101, 102, 104, and 105 are displayed at a size smaller than that in the normal state. This applies to a case in which the number of cameras that are confirmed to have captured a congestion state is two or more. That is, the captured images of the cameras that are confirmed to have captured a congestion state are displayed at a size larger than that in the normal state, and the captured images of the cameras that are confirmed to have captured a non-congestion state are displayed at a size smaller than that in the normal state.

The integrated determination unit 204 determines whether (rule 2) described above and (rule 3) below are satisfied. A captured image of a camera that is confirmed to have captured a non-congestion state may be displayed at a size larger than that in the normal state, and captured images of the remaining cameras may be displayed at a size smaller than that in the normal state.

(Rule 3) The self camera is capturing a non-congestion state and all neighboring cameras corresponding to the self camera are capturing a congestion state.

Note that in the examples of FIGS. 5A and 5B, the display size of the captured image of the camera that is confirmed to have captured a congestion state is different from that of the captured image of the camera that is confirmed to have captured a non-congestion state. Additionally or alternatively, another element may be different for each captured image. For example, additionally or alternatively, the captured image of the camera that is confirmed to have captured a congestion state may be displayed with a frame of a conspicuous color such as red. That is, as long as it is possible to highlight the captured image of the camera that is confirmed to have captured a congestion state as compared with the captured image of the camera that is confirmed to have captured a non-congestion state, the display form of each image is not limited to a specific one.

As described above, every time each of the cameras 101 to 105 inputs a captured image to the information processing apparatus 106, the information processing apparatus 106 performs the above-described processing, and confirms whether each of the cameras 101 to 105 has captured a congestion state or non-congestion state. The information processing apparatus 106 displays, on the display unit 205, the captured image of each of the cameras 101 to 105 in a display form according to the confirmation result of the camera.

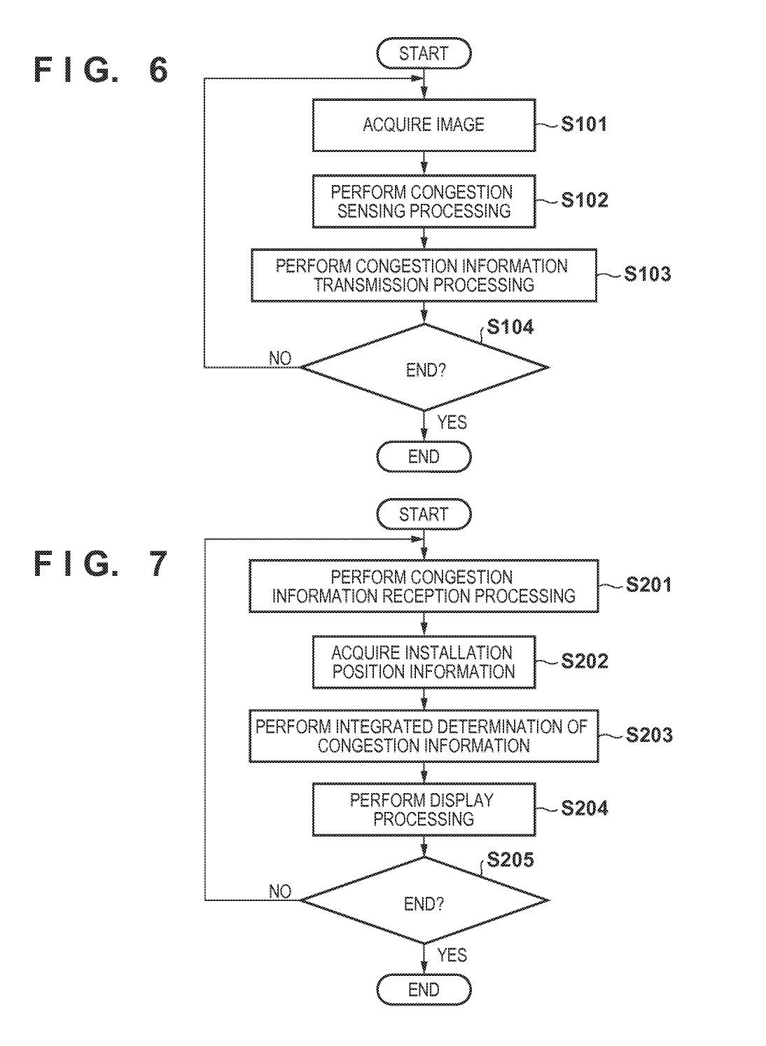

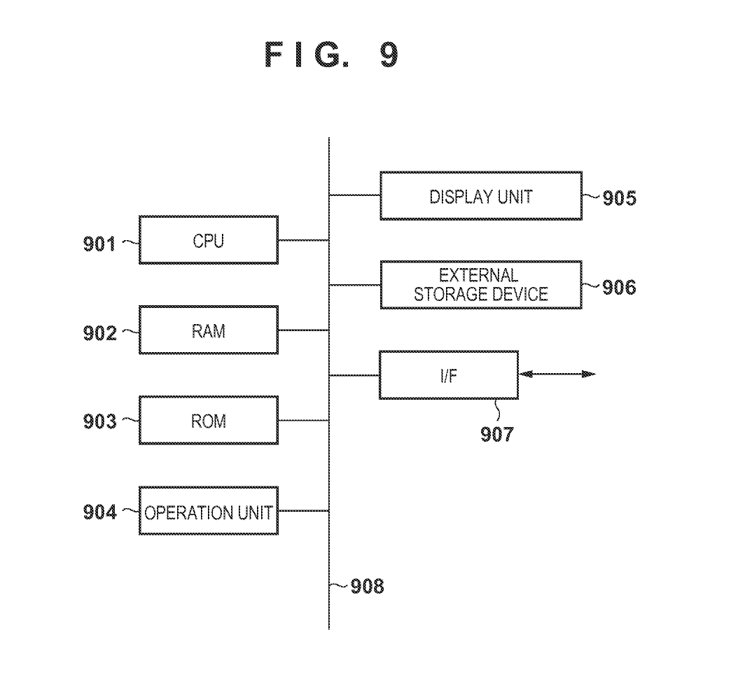

The above-described processing executed by the video reception units 201a to 201e and the congestion sensing processing units 202a to 202e will be explained with reference to FIG. 6 which shows the flowchart of the processing. Note that details of processing in each step are as described above and a brief description will be provided below. Note that when a computer executes video reception and congestion sensing processing, as will be described later with reference to FIG. 9, the flowchart of FIG. 6 shows a program of video reception and congestion sensing processing executed by the computer. The computer reads out the program from a storage medium storing the program, and executes it. The information processing apparatus 106 includes the computer and the storage medium storing the program.

In step S101, each of the video reception units 201a to 201e receives the captured image sent from a corresponding one of the cameras 101 to 105, and sends the received image to a corresponding one of the congestion sensing processing units 202a to 202e of the succeeding stage.

In step S102, each of the congestion sensing processing units 202a to 202e generates congestion information based on the captured image received from a corresponding one of the video reception units 201a to 201e. The congestion information contains the degree of congestion and capturing information indicating a congestion state or non-congestion state. In step S103, each of the congestion sensing processing units 202a to 202e sends the congestion information generated in step S102 to the integrated determination unit 204 of the succeeding stage.

If an end condition is satisfied, for example, if an end instruction is input, the process ends through step S104. On the other hand, if no end condition is satisfied, the process returns to step S101 through step S104, and each of the video reception units 201a to 201e stands by for reception of a captured image from a corresponding one of the cameras 101 to 105.

The processing executed by the integrated determination unit 204 will be described with reference to FIG. 7 that shows the flowchart of the processing. Note that when a computer executes integrated determination, as will be described later with reference to FIG. 9, the flowchart of FIG. 7 shows a program of integrated determination executed by the computer. The computer reads out the program from a storage medium storing the program, and executes it. The information processing apparatus 106 includes the computer and the storage medium storing the program.

In step S201, the integrated determination unit 204 acquires the congestion information sent from each of the congestion sensing processing units 202a to 202e. In step S202, the integrated determination unit 204 acquires the installation position information from the installation position management unit 203. The neighboring camera of each camera may be determined by referring to the design drawing of the station indicating the installation position and capturing direction of each camera.

In step S203, by using the congestion information acquired in step S201 and the installation position information acquired in step S202, the integrated determination unit 204 confirms whether each of the cameras 101 to 105 is capturing a congestion state or non-congestion state.

In step S204, the display unit 205 displays the captured image of each of the cameras 101 to 105 in a display form according to the confirmation result of the camera. If an end condition is satisfied, for example, if an end instruction is input, the process ends through step S205. On the other hand, if no end condition is satisfied, the process returns to step S201 through step S205, and the integrated determination unit 204 stands by for reception of congestion information from each of the congestion sensing processing units 202a to 202e.

A plurality of regions may be set in a captured image, and the respective regions may be considered as the captured images of different cameras, thereby performing each process described in the first embodiment.

In the first embodiment, processing (congestion sensing processing) is performed to confirm whether each camera has captured a congestion state or non-congestion state. However, with the same processing, it is possible to perform processing (abnormal sensing processing) of confirming whether each camera has captured an abnormal state or non-abnormal state.

For example, each of the congestion sensing processing units 202a to 202e may extract a flow vector or CHLAC (Higher-order Local Auto-Correlation) feature amount from the captured image, and performs abnormal sensing processing using the extracted information. As a method of obtaining the degree of abnormal based on the extracted information and a rule for determining based on the extracted information whether an abnormal state has been captured, there are various methods and rules. In this case, the degree of congestion and capturing information correspond to the degree of abnormal and capturing information (information indicating whether an abnormal state or non-abnormal state has been captured), respectively.

The congestion sensing processing units 202a to 202e may be respectively provided in the cameras 101 to 105, instead of the information processing apparatus 106. In this case, each of the video reception units 201a to 201e receives the captured image of a corresponding one of the cameras 101 to 105 and the congestion information of a corresponding one of the congestion sensing processing units 202a to 202e, and sends the received image and information to the integrated determination unit 204.

In the second embodiment, captured images are received from a plurality of cameras, and the installation positions of the cameras are estimated based on pedestrian traffic obtained by performing congestion sensing processing and image analysis of the captured images, and registered in the above-described installation position information. After that, integrated determination processing and display control are performed using the estimated installation positions of the cameras, similarly to the first embodiment.

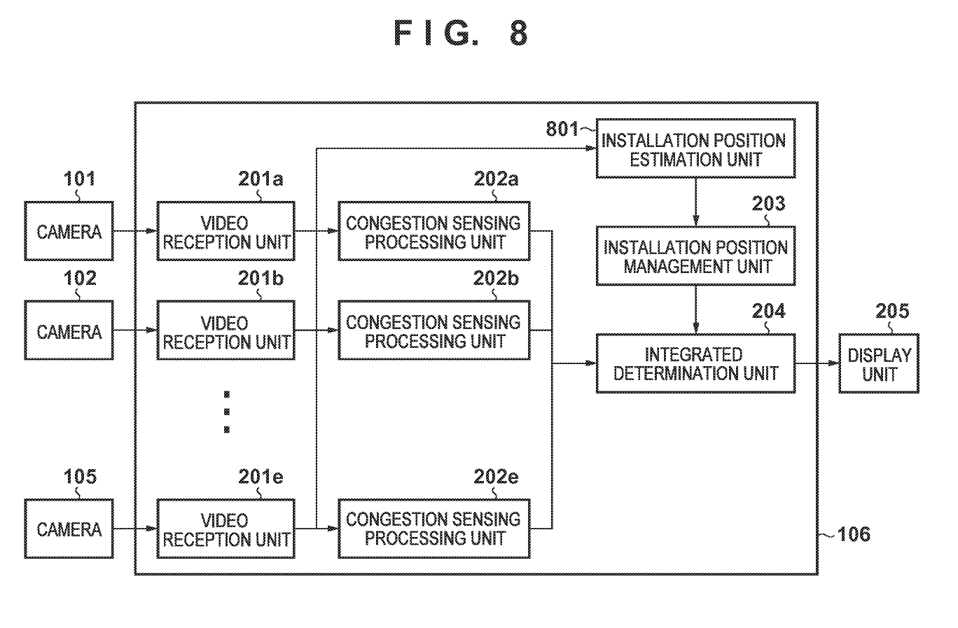

The difference from the first embodiment will be mainly described below. Details are the same as in the first embodiment unless specifically stated otherwise. An example of the functional arrangement of an information processing system according to this embodiment will be explained with reference to a block diagram shown in FIG. 8. An arrangement shown in FIG. 8 is obtained by adding an installation position estimation unit 801 to an information processing apparatus 106 shown in FIG. 2.

The installation position estimation unit 801 acquires a captured image from each of video reception units 201a to 201e, obtains pedestrian traffic by performing image analysis processing on the acquired captured images, and estimates camera installation positions based on the obtained pedestrian traffic. The installation position estimation unit 801 registers the estimated installation position of each of cameras 101 to 105 in installation position information managed by an installation position management unit 203.

The operation of the installation position estimation unit 801 will now be described. The installation position estimation unit 801 performs human body detection processing and tracking processing for the captured image acquired from each of the video reception units 201a to 201e, thereby collecting the loci of people (tracking targets) in the captured images. The installation position estimation unit 801 performs face detection processing for each tracking target, and specifies a face region, thereby extracting face features necessary for face collation processing.

The installation position estimation unit 801 performs face collation processing using the face features extracted in advance, and determines whether the tracking target that has moved outside one captured image appears in another captured image. If the collation processing has succeeded, the installation position estimation unit 801 considers that the preceding camera and current camera which capture the same person are adjacent to each other, and generates pedestrian traffic information. The installation position estimation unit 801 acquires pieces of pedestrian traffic information from a plurality of persons, and summarizes the pieces of pedestrian traffic information, thereby estimating the installation position relationship between the cameras.

Note that if the time from when the tracking target moves outside one captured image until the tracking target appears in another captured image is equal to or longer than a predetermined time, the likelihood of pedestrian traffic information is set low. When estimating the installation position relationship between cameras, a control operation of using only pieces of pedestrian traffic information whose likelihood is equal to or higher than a predetermined value may be additionally performed. Note that a method of determining whether the same person appears is not limited to the method using face collation processing, and need only be recognition processing such as gait recognition processing that can identify an individual from an image.

Each function unit of the information processing apparatus 106 shown in FIG. 2 or 8 may be implemented by a hardware component or software component (computer program). In this case, any apparatus capable of executing the computer program is applicable to the information processing apparatus 106. An example of the hardware arrangement of an apparatus applicable to the information processing apparatus 106 will be described with reference to a block diagram shown in FIG. 9.

A CPU 901 controls the operation of the whole apparatus by executing various processes using computer programs and data stored in a RAM 902 and a ROM 903, and executes each process described as processing to be executed by the information processing apparatus 106 to which this apparatus is applied.

The RAM 902 has an area for temporarily storing computer programs and data loaded from an external storage device 906 and data externally received via an I/F (interface) 907. The RAM 902 also has a work area used by the CPU 901 to execute various processes. That is, the RAM 902 can provide various areas, as needed. The ROM 903 stores the setting data, boot program, and the like of this apparatus.

An operation unit 904 includes a mouse and keyboard. When the user of the apparatus operates the operation unit 904, various instructions can be input to the CPU 901. For example, capturing instructions for the cameras 101 to 105 and the like can be input by operating the operation unit 904.

A display unit 905 includes a CRT or a liquid crystal screen, and can display the processing result of the CPU 901 using images, characters, and the like. The display unit 905 functions as the display unit 205 shown in FIG. 2 or 8.

The external storage device 906 is a mass information storage device represented by a hard disk drive device. The external storage device 906 saves an OS (Operating System), and computer programs and data used to cause the CPU 901 to execute each process described above as processing to be executed by the information processing apparatus 106.

The computer programs include the following computer programs, that is, computer programs for causing the CPU 901 to execute respective processes described above as processes to be executed by the video reception units 201a to 201e, the congestion sensing processing units 202a to 202e, the installation position management unit 203, the integrated determination unit 204, and the installation position estimation unit 801. The data include various kinds of information described as known information such as installation position information.

The computer programs and data saved in the external storage device 906 are loaded to the RAM 902 under the control of the CPU 901, as needed, and processed by the CPU 901.

An external device is connectable to the I/F 907. For example, the cameras 101 to 105 shown in FIG. 2 or 8 can be connected. That is, a captured image of each of the cameras 101 to 105 is sent to the RAM 902 or external storage device 906 via the I/F 907.

All the above-described respective units are connected to a bus 908. Note that the arrangement of the apparatus applicable to the information processing apparatus 106 is not limited to that shown in FIG. 9. Any arrangement may be adopted as long as it is possible to execute the computer programs corresponding to the respective function units of the information processing apparatus 106 shown in FIG. 2 or 8.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-244335, filed Nov. 26, 2013 which is hereby incorporated by reference herein in its entirety.

What is claimed is:

1. A display control apparatus for controlling display of images captured by a plurality of cameras, comprising:
a comparison unit configured to compare an analysis result corresponding to an image captured by a first camera of the plurality of cameras with an analysis result corresponding to an image captured by a second camera corresponding to the first camera; and
a control unit configured to control to display the image captured by the first camera in a form based on a result of the comparison by said comparison unit.

2. The apparatus according to claim 1, wherein said comparison unit compares the analysis result corresponding to the image captured by the first camera with the analysis result corresponding to the image captured by the second camera installed at a position having a predetermined relationship with the first camera.

3. The apparatus according to claim 1, wherein said control unit controls to display the image captured by the first camera at a size based on the result of the comparison by said comparison unit.

4. The apparatus according to claim 1, wherein if it is decided that a degree of congestion corresponding to the image captured by the first camera is a first degree of congestion higher than a predetermined degree of congestion and a degree of congestion corresponding to the image captured by the second camera is a second degree of congestion lower than the first degree of congestion by not less than a predetermined difference, said control unit controls to display the image captured by the first camera in a predetermined form.

5. The apparatus according to claim 1, wherein said comparison unit compares a first degree of congestion corresponding to the first image captured by the first camera with a second degree of congestion corresponding to the second image captured by the second camera corresponding to the first camera and a third degree of congestion corresponding to a third image captured by a third camera corresponding to the first camera.

6. The apparatus according to claim 1, wherein said comparison unit compares a degree of abnormal obtained from the image captured by the first camera with a degree of abnormal obtained from the image captured by the second camera corresponding to the first camera.

7. The apparatus according to claim 1, further comprising a unit configured to associate the first camera with the second camera based on movement of a moving object detected in the image captured by the first camera.

8. A display control method of controlling display of images captured by a plurality of cameras, comprising:
comparing an analysis result corresponding to an image captured by a first camera of the plurality of cameras with an analysis result corresponding to an image captured by a second camera corresponding to the first camera; and
controlling to display the image captured by the first camera in a form based on a result of the comparison.

9. The method according to claim 8, wherein in the comparing, the analysis result corresponding to the image captured by the first camera is compared with the analysis result corresponding to the image captured by the second camera installed at a position having a predetermined relationship with the first camera.

10. The method according to claim 8, wherein in the controlling, it is controlled to display the image captured by the first camera at a size based on the result of the comparison.

11. The method according to claim 8, wherein in the controlling, if it is decided that a degree of congestion corresponding to the image captured by the first camera is a first degree of congestion higher than a predetermined degree of congestion and a degree of congestion corresponding to the image captured by the second camera is a second degree of congestion lower than the first degree of congestion by not less than a predetermined difference, it is controlled to display the image captured by the first camera in a predetermined form.

12. The method according to claim 8, wherein in the comparing, a first degree of congestion corresponding to the first image captured by the first camera is compared with a second degree of congestion corresponding to the second image captured by the second camera corresponding to the first camera and a third degree of congestion corresponding to a third image captured by a third camera corresponding to the first camera.

13. The method according to claim 8, wherein in the comparing, a degree of abnormal obtained from the image captured by the first camera is compared with a degree of abnormal obtained from the image captured by the second camera corresponding to the first camera.

14. The method according to claim 8, further comprising associating the first camera with the second camera based on movement of a moving object detected in the image captured by the first camera.

15. A non-transitory computer-readable storage medium storing a computer program for causing a computer to control display of images captured by a plurality of cameras, the program for causing the computer to:
compare an analysis result corresponding to an image captured by a first camera of the plurality of cameras with an analysis result corresponding to an image captured by a second camera corresponding to the first camera; and
control to display the image captured by the first camera in a form based on a result of the comparison.

16. The medium according to claim 15, wherein in the comparing, the analysis result corresponding to the image captured by the first camera is compared with the analysis result corresponding to the image captured by the second camera installed at a position having a predetermined relationship with the first camera.

17. The medium according to claim 15, wherein in the controlling, it is controlled to display the image captured by the first camera at a size based on the result of the comparison.

18. The medium according to claim 15, wherein the program for further causing the computer to associate the first camera with the second camera based on movement of a moving object detected in the image captured by the first camera.
